(19) United States
(12) Patent Application Publication
(10) Pub. No.: US 2021/0396515 A1
(43) Pub. Date: Dec. 23, 2021

(54) TSUNAMI PREDICTION DEVICE, METHOD AND COMPUTER-READABLE STORAGE MEDIUM

(71) Applicant: TOKYO ELECTRIC POWER SERVICES CO., LTD., Koto-ku, Tokyo (JP)

(72) Inventors: Tatsuto Kimura, Koto-ku, Tokyo (JP); Toshimichi Kaneto, Chiyoda-ku, Tokyo (JP); Kyohei Yamashita, Chiyoda-ky, Tokyo (JP)

(73) Assignee: TOKYO ELECTRIC POWER SERVICES CO., LTD., Koto-ku, Tokyo (JP)

(21) Appl. No.: 17/281,199

(22) PCT Filed: Sep. 30, 2019
(86) PCT No.: PCT/JP2019/038582

§ 371 Date: Mar. 29, 2021

(30) Foreign Application Priority Data
Oct. 1, 2018 (JP) 2018-186537

(51) Int. Cl. G01C 13/00; G01V 1/00; G01S 13/58

(52) U.S. Cl. CPC G01C 13/006; G01S 13/58; G01V 1/008

(57) ABSTRACT

A prediction portion predicts states including a water level of the wave at a prediction subject location. In a case in which inputs of the flow velocity in a line-of-sight direction of the wave at each observation location have been received, an estimation portion estimates states of waves including the water level thereof at the prediction subject location. The estimation of the states is based on a difference between the flow velocity in a line-of-sight direction of the wave at each input observation location, and the flow velocity in a line-of-sight direction of the wave at each input observation location obtained by converting states of the wave using an observation matrix. A determination portion causes the predictions of the states and the estimation of the states to be repeated until predetermined conditions have been satisfied.

### TECHNICAL FIELD

The present disclosure relates to a tsunami prediction device, method, and computer-readable storage medium and, in particular, to a tsunami prediction device, method, and computer-readable storage medium that are used to predict a water level of a wave.

### BACKGROUND ART

Conventionally, technology has been developed to predict a wave height of a tsunami (i.e., a height of a water level of a wave). In Japanese Patent Application Publication Laid-Open (JP-A) No. 2016-85206, the arrival time of a tsunami at a prediction subject location, and the water level of the tsunami are predicted by, for example, estimating a water level distribution of a tsunami from a tsunami flow velocity distribution in a line-of-sight direction observed using marine radar, and performing a tsunami propagation simulation using the estimation results as initial conditions.

### SUMMARY OF THE INVENTION

### Technical Problem

However, in the technology described in JP-A No. 2016-85206, when estimating the water level distribution of a tsunami, the problem has existed that, due to factors such as the equation of motion being simplified and the like, the prediction accuracy of the tsunami wave height and arrival time has not been particularly accurate. One of these factors has been, for example, the fact that the flow velocity in a θ direction in a cylindrical coordinate system is not used as an input value. Moreover, of the respective items in the equation of motion, a plurality of items are disregarded when solving the equation. As far as the prediction accuracy is concerned, because the maximum water level and the minimum water level are predicted using an envelope of the respective simulation results, they have not been able to accurately express a waveform. As far as a comparison of the simulation results is concerned, because it is not always the case that the most recent simulation results are the best results, considerable time and trouble have been required in order to compare the size and the like thereof with past prediction results.

Moreover, from the standpoints of economic viability and practicality and the like, it is desirable that it be possible to predict a tsunami solely from the flow velocity in a line-of-sight direction that can be observed from the marine radar at a single base station.

The present disclosure was conceived in view of the above-described circumstances, and it is an object thereof to provide a tsunami prediction device, method, and computer-readable storage medium that enable the water level of a wave to be accurately predicted.

### Solution to the Problem

In order to achieve the above object, a tsunami prediction device according to a first aspect of the present disclosure is a tsunami prediction device that, taking a flow velocity in a light-of-sight direction of a wave at each observation location as inputs, predicts a water level of the wave at a prediction subject location. This tsunami prediction device includes an input portion that receives inputs of the flow velocity in a line-of-sight direction of the wave at each observation location. The tsunami prediction device also includes a prediction portion that predicts states including the water level of the wave at the prediction subject location. The tsunami prediction device also includes an estimation portion that, in a case in which inputs of the flow velocity in a line-of-sight direction of the wave at each observation location have been received, estimates states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix. The tsunami prediction device also includes a determination portion that causes the predictions of the states by the prediction portion and the estimation of the states by the estimation portion to be repeated until predetermined conditions have been satisfied. In addition, a structure is employed in which the predictions of the states by the prediction portion are made based on the states estimated by the estimation portion in the immediately previous repetition, or on the states predicted by the prediction portion in the immediately previous repetition.

Moreover, in the tsunami prediction device according to a second aspect of the present disclosure, it is also possible for the states to include a water level and a linear flow rate.

In the tsunami prediction device according to a third aspect of the present disclosure, it is also possible for the states to include a water level, a linear flow rate in the line-of-sight direction, and a linear flow rate in an orthogonal direction relative to the line-of-sight direction.

In the tsunami prediction device according to a fourth aspect of the present disclosure, it is also possible for the observation matrix to be determined by performing a linear approximation on a relationship between the flow velocity in the line-of-sight direction, the linear flow rate in the line-of-sight direction, and a still water depth.

A tsunami prediction method according to a fifth aspect of the present disclosure is a tsunami prediction method in which, taking a flow velocity in a light-of-sight direction of a wave at each observation location as inputs, a water level of the wave at a prediction subject location is predicted, and is characterized in that a computer executes processing including receiving inputs of a flow velocity in a line-of-sight direction of the wave at each observation location, and predicting states including the water level of the wave at the prediction subject location. Moreover, in a case in which inputs of the flow velocity in a line-of-sight direction of the wave at each observation location have been received, estimating states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix, and causing the predictions of the states and the estimations of the states to be repeated until predetermined conditions have been satisfied. In addition, the predictions of the states are made based on the states estimated in the immediately previous repetition, or on the states predicted in the immediately previous repetition.

A computer-readable storage medium according to a sixth aspect of the present disclosure is a computer-readable storage medium that, taking a flow velocity in a light-of-sight direction of a wave at each observation location as inputs, predicts a water level of the wave at a prediction subject location, and that causes a computer to execute processing including receiving inputs of a flow velocity in a line-of-sight direction of the wave at each observation location, and predicting states including the water level of the wave at the prediction subject location. Moreover, in a case in which inputs of the flow velocity in a line-of-sight direction of the wave at each observation location have been received, estimating states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix, and cawing the predictions of the states and the estimations of the states to be repeated until predetermined conditions have been satisfied. In addition, the predictions of the states are made based on the states estimated in the immediately previous repetition, or on the states predicted in the immediately previous repetition.

### Advantageous Effects of the Invention

According to the tsunami prediction device, method, and computer-readable storage medium of the present disclosure, inputs of a flow velocity in a light-of-sight direction of a wave at each observation location are received. States including a water level of the wave at a prediction subject location are then predicted. In a case in which inputs of the flow velocity in a line-of-sight direction of a wave at each observation location have been received, states of the wave including the water level thereof at the prediction subject location are estimated based on a difference between the input flow velocity in a line-of-sight direction of the wave at each observation location, and the flow velocity in a line-of-sight direction of the wave at each input observation location that is obtained by converting predicted states of the wave including the water level thereof at the prediction observation subject location using a predetermined observation matrix. The predictions of the states and the estimations of the states are repeated until predetermined conditions have been satisfied. The predictions of the states are made based on the states estimated in the immediately previous repetition, or on the states predicted in the immediately previous repetition. As a result, the excellent effect is achieved that it is possible to accurately predict the water level of a wave.

### BRIEF DESCRIPTION OF THE DRAWINGS

FIG. 1 is a block diagram showing a structure of a tsunami prediction device according to an exemplary embodiment of the present disclosure.

FIG. 2 is a flowchart showing a tsunami prediction processing routine of a tsunami prediction device according to an exemplary embodiment of the present disclosure.

FIG. 3 is a view showing an example of an observation range of marine radar in an experimental example.

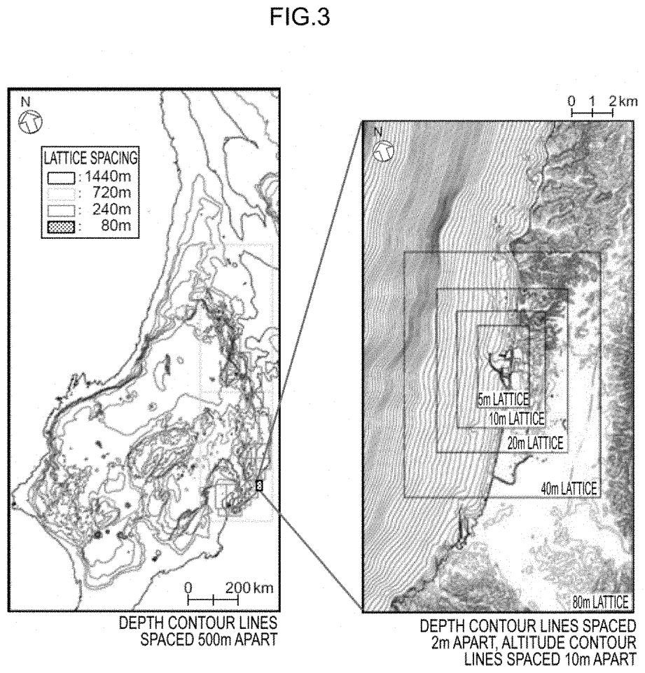

FIG. 4 is a view showing a calculation area of a data assimilation tsunami prediction in a test example.

FIG. 5 is a view showing a position of each wave source in a test example.

FIG. 6 shows an example of prediction results in a test example.

### DESCRIPTION OF THE EMBODIMENTS

Hereinafter, an exemplary embodiment of the present disclosure will be described in detail with reference to the drawings.

Firstly, a data assimilation process and a prediction principal of an exemplary embodiment of the present disclosure will be described.

In the present exemplary embodiment, without assuming a water level distribution from the flow velocity distribution of a tsunami in a line-of-sight direction obtained from marine radar, the arrival time of a tsunami and the wave height of a tsunami (i.e., the water level height thereof) are predicted by performing a tsunami propagation simulation using a flow velocity distribution. When performing this simulation, an affinity between analysis values and observation values is increased by using a data assimilation procedure that is used in weather prediction or the like.

Next, a tsunami prediction method that uses a data assimilation procedure will be described.

Data assimilation is a procedure in which observation values are incorporated into a model (i.e., a simulation) so as to enable results that are closer to the true values to be obtained. In the present exemplary embodiment, from the standpoint of the analysis calculation load, an optimal interpolation method, which is a static assimilation procedure in which it is assumed that error information in the background field does not change over time is used. In an optimal interpolation method, as is shown in the following Formula (1), an optimal estimation value x^{a} is provided by the sum of a forecast value x^{b}, which is obtained as a simulation result, and a value obtained by applying a weighting to an error relative to an observation value y.

x^{a}=x^{b}+W[y−HX^{b}] (1)

H is an observation matrix and W is a weighting matrix. The observation matrix H is a matrix for converting from the forecast value x^{b} at calculation lattice points into a value at an observation location, and in a case in which the observation value y and the forecast value x^{b} are the same physical quantity, expresses a spatial interpolation. The calculation lattice points are lattice points that are set at a predetermined lattice spacing within an observation range. The weighting matrix W is set so as to minimize error variance in the estimation values x^{a}. An estimation error is provided by the following Formula (2).

$$\begin{matrix}{ɛ}^{a} = {x}^{a} - {x}^{t} \\ = ( {x}^{b} - {x}^{t} ) + W [ ( y - {Hx}^{t} ) - H ( {x}^{b} - {x}^{t} ) ] \\ = {ɛ}^{b} + W ( {ɛ}^{o} - {Hɛ}^{b} )\end{matrix} \\ {x}^{t} : the true values \qquad ( 2 )$$

If no correlation is assumed between a background error ε^{b}, which is a simulation error, and a measurement error ε^{o}, then an estimation error covariance is found using the following Formula (3).

$$\begin{matrix}〈 {ɛ}^{a} {ɛ}^{aT} 〉 = 〈 {[ {ɛ}^{b} + W ( {ɛ}^{o} - {Hɛ}^{b} ) ] [ {ɛ}^{b} + W ( {ɛ}^{o} - {Hɛ}^{b} ) ]}^{T} 〉 \\ = 〈 {ɛ}^{b} {ɛ}^{bT} 〉 - 〈 {ɛ}^{b} {ɛ}^{bT} 〉 {H}^{T} {W}^{T} + W 〈 {ɛ}^{o} {ɛ}^{oT} 〉 {W}^{T} - \\ WH 〈 {ɛ}^{b} {ɛ}^{bT} 〉 + WH 〈 {ɛ}^{b} {ɛ}^{bT} 〉 {H}^{T} {W}^{T} \\ = B - {BH}^{T} {W}^{T} + {WRW}^{T} - WHB + {WHBH}^{T} {W}^{T}\end{matrix} \qquad ( 3 )$$

Here, B and R are defined as is shown by the following Formula (4) and Formula (5).

B= [symbol] ε^{b}ε^{bT} [symbol] (4)

[symbol]

= [symbol] ε^{o}ε^{oT} [symbol] (5)

Diagonal components of the estimation error covariance of the above Formula (3) are the error variance in the estimation values. If a sum of the diagonal components is differentiated using the weighting matrix W, then the following Formula (6) is obtained.

$$\frac{\partial }{\partial W} trace ( 〈 {ɛ}^{b} {ɛ}^{b T} 〉 ) = - 2 B {H}^{T} + 2 W R + 2 {WHBH}^{T} \qquad ( 6 )$$

Here, the fact that B and R are a symmetric matrix is utilized. If this is set at 0, then the optimum weighting matrix W satisfies the following Formula (7).

W(R+HBH^{T})=BH^{T} (7)

If components of a background error covariance matrix HBH^{T} between observation locations i and j are taken as bᵢⱼ, components of an observation error covariance matrix R are taken as rᵢⱼ, and components of a background error covariance matrix BH^{T} between a calculation lattice point g and the observation location i is taken as bp, then a weighting w_{gj} of an observation value of the observation location j relative to the calculation lattice point g can be determined from the simultaneous linear equation shown below in Formula (8).

$${\sum }_{j = 1}^{m} {w}_{g j} ( {b}_{ij} + {r}_{ij} ) = {b}_{gi} \qquad ( 8 )$$

Taking σᵢ^{b} as a standard deviation of the background error at the observation location i, σ_{g}^{b} as a standard deviation of the background error at the calculation lattice point g, and σᵢ^{o} as a standard deviation of the observation error at the observation location i, then if both sides are divided by σᵢ^{b} and σ_{g}^{b}, a transformation as in the following Formula (9) can be obtained.

$${\sum }_{j = 1}^{m} {w}_{gj} \frac{{σ}_{j}^{b}}{{σ}_{g}^{b}} ( {μ}_{ij}^{b} + {μ}_{ij}^{o} \frac{{σ}_{i}^{o} {σ}_{j}^{o}}{{σ}_{i}^{b} {σ}_{j}^{b}} ) = {μ}_{gi}^{b} \qquad ( 9 )$$

μᵢⱼ^{b} is a correlation coefficient of background errors at the observation location i and the observation location j, and is expressed as

$${μ}_{ij}^{b} = \frac{{b}_{ij}}{{σ}_{i}^{b} {σ}_{j}^{b}}$$

μᵢⱼ^{O} is a correlation coefficient of observation errors at the observation location i and the observation location j, and is expressed as

$${μ}_{ij}^{o} = \frac{{r}_{i j}}{{σ}_{i}^{o} {σ}_{j}^{o}}$$

μ_{gi}^{b} is a correlation coefficient of background errors at the calculation lattice point g and the observation location j, and is expressed as

$${μ}_{gi}^{b} = \frac{{b}_{gi}}{{σ}_{g}^{b} {σ}_{i}^{b}} .$$

Furthermore, if an equation in which there is no relation in the observation errors between observation locations is assumed as being

μᵢⱼ^{o}=δᵢⱼ,

then this can be simplified as in the following Formula (10).

$${\sum }_{j = 1}^{m} {w}_{gj} \frac{{σ}_{j}^{b}}{{σ}_{g}^{b}} ( {μ}_{ij}^{b} + {μ}_{ij}^{o} {ρ}_{i} {ρ}_{j} ) = {μ}_{gi}^{b} \qquad ( 10 )$$

Using the above-described data assimilation method, states of a wave including the water level thereof are predicted.

Next, the prediction principle will be described. As is described in Patent Document 1, a simulation that is used to predict the behavior of a tsunami, namely, the arrival time of the tsunami and the state of a water level η of the tsunami can be derived using a fundamental equation for long wave theory that is formed from the following Formula (11) which is a conservation of mass equation of a two-dimensional Cartesian coordinate system having an x-axis and a y-axis, Formula (12) which is an equation of motion, and Formula (13).

$$\begin{matrix} \frac{\partial η}{\partial t} + \frac{\partial M}{\partial x} + \frac{\partial N}{\partial y} = 0 & ( 11 ) \\ \frac{\partial M}{\hat{o} t} + \frac{\partial }{\partial x} ( \frac{{M}^{2}}{D} ) + \frac{\partial }{\partial y} ( \frac{M N}{D} ) + g D \frac{\partial η}{\partial x} + \frac{{gn}^{2}}{{D}^{\frac{7}{3}}} ( M \sqrt{{M}^{2} + {N}^{2}} ) = 0 & ( 12 ) \\ \frac{\partial N}{\partial t} + \frac{\partial }{\partial x} ( \frac{M N}{D} ) + \frac{\partial }{\partial y} ( \frac{{N}^{2}}{D} ) + gD \frac{\partial η}{\partial y} + \frac{g {n}^{2}}{{D}^{\frac{7}{3}}} ( N \sqrt{{M}^{2} + {N}^{2}} ) = 0 & ( 13 )\end{matrix}$$

In Formulae (11)˜(13), η is the wave height of the tsunami, M is a linear flow rate in the x-axial direction, N is a linear flow rate in the y-axial direction, and n is a seabed coefficient of friction. D is the total water depth and, using a still water depth h and the wave height η, D=h+η. t is the time, and g is a gravitational acceleration.

In long wave theory, because the flow velocity of a tsunami can be assumed to be constant in the depth direction (i.e., in a z-axial direction), a flow velocity U of the tsunami in the x-axial direction, and a flow velocity V of the tsunami in the y-axial direction can be calculated respectively as U=M/D and V=N/D. In other words, the measured flow velocity U in the x-axial direction and flow velocity V in the y-axial direction of the sea surface are determined using coordinates on an xy plane. Accordingly, in the estimation of the wave height, there is no need for a database or an empirical formula in order to associate the flow velocity U in the x-axial direction and flow velocity V in the y-axial direction with the tsunami wave height η, and it is possible, based on the above-described tsunami fundamental equation, to calculate the tsunami wave height r from the measured tsunami flow velocity U in the x-axial direction and flow velocity V in the y-axial direction.

Based on the above description, the structure of a tsunami prediction device will now be described.

[Structure of a Tsunami Prediction Device According to an Exemplary Embodiment of the Present Disclosure]

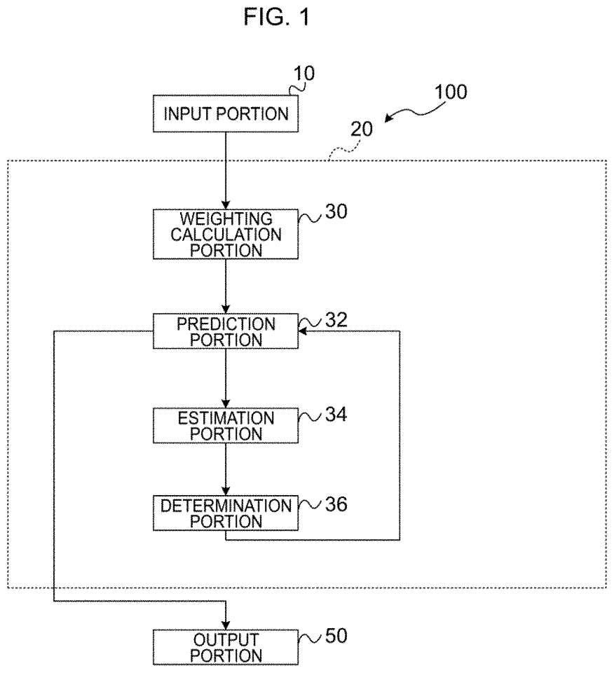

Next, the structure of a tsunami prediction device according to an exemplary embodiment of the present disclosure will be described. As is shown in FIG. 1, a tsunami prediction device 100 according to an exemplary embodiment of the present disclosure can be formed by a computer that includes a CPU, RAM, and ROM in which are stored programs (i.e non-transitory computer readable storage medium) and various types of data that are used to execute a tsunami prediction processing routine (described below). As is shown in FIG. 1, functionally, this tsunami prediction device 100 is provided with an input portion 10, a computing unit 20, and an output portion 50. Note that the tsunami prediction device 100 can be realized in the form, for example, of a computer. This computer is provided with a central processing unit (CPU), memory which serves as a temporary storage area, and a non-transitory storage portion. In addition, the computer is provided with an input/output interface (I/F), a read/write (R/W) portion that controls the reading and writing of data in a storage medium, a network interface (I/F) that is connected to a network such as the Internet. The storage portion may be realized in the form of a hard disk drive (HDD), a solid state drive (SSD), or flash memory or the like. A program that is used to enable a computer to function as the tsunami prediction device 100 is stored in the storage portion which serves as a storage medium. The CPU reads and then expands this program from the storage portion, and sequentially executes the respective processes stored on the program. As a result of the CPU executing the respective processes in the program, the CPU operates as the respective portions of the computing unit 20 shown in the above-described FIG. 1.

The input portion 10 receives observation values y of the flow velocity u in a line-of-sight direction of a wave at each observation location i. The observation values y can be received at any time from marine radar.

The computing unit 20 is formed so as to include a weighting calculation portion 30, a prediction portion 32, an estimation portion 34, and a determination portion 36.

The weighting calculation portion 30 calculates the weighting matrix W, which is made up of the weightings w_{gi}, in accordance with the above-described Formula (8), based on the background error covariance matrix HBH^{T}, the observation error covariance matrix R, and the background error covariance matrix BH^{T} that were determined using the observation values y. The weighting matrix W is a weighting matrix whose purpose is to ensure that the error variance of the estimation values x^{a} is minimized. Note that values, other than the observation values y, that are required in order to determine the background error covariance matrix HBH^{T}, the observation error covariance matrix R, and the background error covariance matrix BH^{T} may be established via experiment or the like.

Here, the observation results of the observation values y are observed as the flow velocity u. In contrast, in a tsunami analysis simulation, because it is necessary to use the water level η, the linear flow rate M in a line-of-sight direction, and the linear flow rate N in an orthogonal direction relative to the line-of-sight direction for the analysis, it is necessary to perform a conversion from the flow velocity u in a line-of-sight direction using the observation matrix H. The flow velocity u is provided by the following Formula (14).

$$u = \frac{M}{D} = \frac{M}{h + η} \qquad ( 14 )$$

D shows the total water depth, and h shows the still water depth. However, because the configuration is non-linear in the state shown in Formula (14), it is not possible to create the observation matrix H. Because of this, an observation matrix H is created using the linear approximation given in the following Formula (15) with the change in the water level relative to the still water depth being taken as being extremely small, and this observation matrix H is used to calculate the weighting matrix W.

$$u \approx \frac{M}{h} \qquad ( 15 )$$

Thereafter, in the estimation portion 34 as well, when the observation matrix H is to be used, an observation matrix H created in the same way using linear approximation may be used.

The prediction portion 32 predicts a forecast value xₙ^{b} of states of a wave including the water level η of the wave at a prediction subject location, the linear flow rate M in a line-of-sight direction, and the linear flow rate N in an orthogonal direction relative to the line-of-sight direction. The prediction subject location corresponds to the aforementioned calculation lattice point g. More specifically, based on an estimation value xₙ₋₁^{a} of a state at the immediately previous timing (n−1), the prediction portion 32 performs a simulation that can be derived from the above-described tsunami fundamental equation, and then predicts a forecast value xₙ^{b} of a state at the next subsequent timing (n). If this estimation of the state at the immediately previous timing (n−1) is not performed by the estimation portion 34, then the forecast value xₙ₋₁^{b} of the state at the immediately previous timing (n−1) is used. The water level η can be updated in accordance with the continuity equation in Formula (11). The linear flow rate M and the linear flow rate N can be updated in accordance with the equations of motion in Formula (12) and Formula (13). Note that n may also be the number of times instead of being the actual time.

When inputs of the observation values y of the flow velocity u in a line-of-sight direction of a wave at each observation location i are received, using the data assimilation procedure given in the above Formula (1), the estimation portion 34 estimates the estimation value xₙ^{a} of states including the water level η at a prediction subject location using the weighting matrix W as a coefficient, based on the difference between the input observation values yₙ of the flow velocity u in a line-of-sight direction of the wave at each observation location i, and the flow velocity Hxₙ^{b} in the line-of-sight direction of the wave at each observation location i obtained by converting the forecast value xₙ^{b} of the predicted states of the wave including the water level η at the prediction subject location using the previously determined observation matrix H.

The determination portion 36 causes the predictions by the prediction portion 32 of the forecast value xₙ^{b} of the states of the wave, and the estimations by the estimation portion 34 of the estimation value xₙ^{a} of the states to be repeated until predetermined conditions are satisfied. A predetermined length of time, or number of times may be set as the predetermined conditions. A forecast value xₙ^{b} may be output from the prediction portion 32 to the output portion 50 each time the prediction is repeated, or may be output after all the repetitions have ended.

[Actions of the Tsunami Prediction Device According to the Exemplary Embodiment of the Present Disclosure]

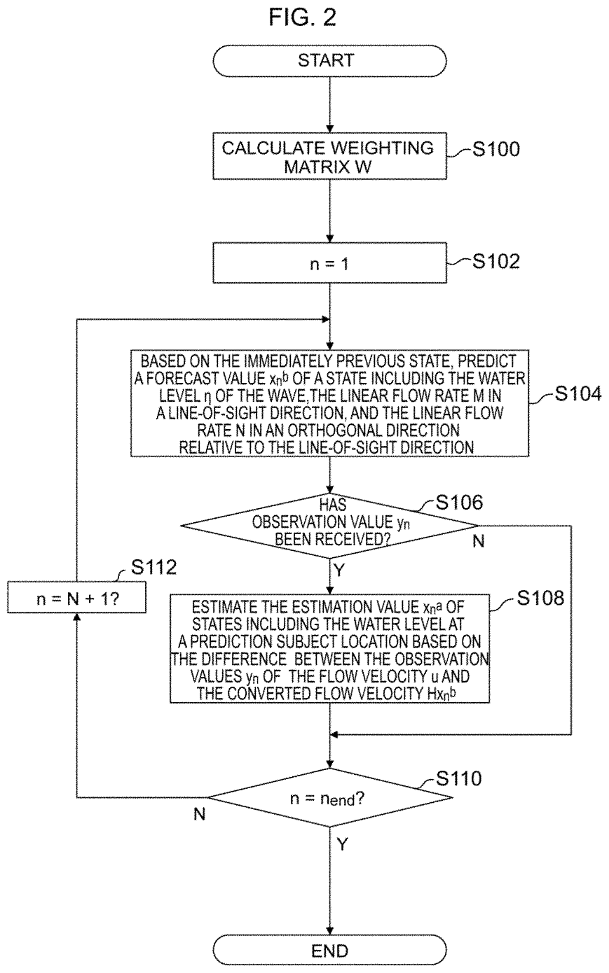

Next, actions of the tsunami prediction device 100 according to the exemplary embodiment of the present disclosure will be described. The tsunami prediction device 100 executes the tsunami prediction processing routine shown in FIG. 2 at any time when the observation values y are received by the input portion 10. For example, a structure in which the observation values y are received every two minutes may be employed. Note that, in a case in which the tsunami prediction device 100 is formed by a computer, the processing of each step described below may be realized as a result of the CPU reading a predetermined program stored in the above-described storage portion, and then executing the respective processes of this program.

Firstly, in step S100, based on the background error covariance matrix HBH^{T}, the observation error covariance matrix R, and the background error covariance matrix BH^{T} that were determined using the observation values y, the CPU calculates the weighting matrix W that is made up of the weightings W_{gi} in accordance with the above-described Formula (8).

Next, in step S102, the CPU sets n, which is the unit used to count the repetitions, to n=1. For example, if n is the time, and the calculation time interval is 1 second, then 1 count is made every 1 second.

In step S104, the CPU predicts the forecast value xₙ^{b} of states of a wave including the water level η of the wave at the prediction subject location, the linear flow rate M in a line-of-sight direction, and the linear flow rate N in an orthogonal direction relative to the line-of-sight direction. For this prediction, based on the estimation value xₙ₋₁^{a} of a state at the immediately previous timing (n−1), a simulation is made that can be derived from the above-described tsunami fundamental equation, and a forecast value xₙ^{b} of the states of the wave is then predicted. If this estimation of the states at the immediately previous timing (n−1) is not performed in step S108, then the forecast value xₙ₋₁^{b} of the states at the immediately previous timing (n−1) is used.

In step S106, the CPU determines whether or not inputs of the observation values y of the flow velocity u in a line-of-sight direction of the wave at each observation location i have been received. If they have been received, the routine moves to step S108. If they have not been received, the routine moves to step S110.

In step S108, using the data assimilation procedure illustrated in the above Formula (1), taking the weighting matrix W as a coefficient, the CPU estimates the estimation value xₙ^{a} of states including the water level η at a prediction subject location based on the difference between the input observation values yₙ of the flow velocity u in a line-of-sight direction of the wave at each observation location i, and the flow velocity Hxₙ^{b} in the line-of-sight direction of the wave at each observation location i obtained by converting the forecast values Xₙ^{b} of the states of the wave including the water level η at the prediction subject location that was predicted for the observation location i using the previously determined observation matrix H.

In step S110, the CPU determines whether or not n=n_{end}. n_{end} are previously determined conditions for n. If n=n_{end}, then it is assumed that the conditions have been satisfied, and the tsunami prediction processing routine is ended. If n does not −n_{end}, then the routine moves to step S112, the count is increased by n=n+1, and the processing of steps S104˜S110 are repeated.

As has been described above, according to the tsunami prediction device according to the embodiment of the present disclosure, inputs of flow velocities in a line-of-sight direction of a wave at each observation point are received, and states including the water level of the wave at a prediction subject location are predicted. In a case in which inputs of the flow velocities in the line-of-sight direction of the wave at each observation point are received, a difference between the flow velocity in the line-of-sight direction of the wave at each input observation location, and the flow velocity in the line-of-sight direction of the wave at each observation point that is obtained by converting states of the wave including the predicted water level thereof at the prediction subject location using a previously determined observation matrix is calculated, and based on this difference, states of the wave including the water level thereof at the prediction subject location are estimated. The predictions of the states and the estimations of the states are then repeatedly performed until predetermined conditions have been satisfied. By performing the predictions of the states based on the state estimated in the immediately prior repetition, or on the state predicted in the immediately prior repetition, it is possible to accurately predict the water level of a wave.

Note that the present disclosure is not limited to the above-described exemplary embodiment and various modifications and the like may be made thereto insofar as they do not depart from the spirit of the present disclosure.

For example, a case in which the weighting matrix W is calculated once by the above-described weighting calculation portion 30 and is then used for the estimation is described as an example, however, the present disclosure is not limited to this and it is also possible to update the background error covariance matrix HBH^{T}, the observation error covariance matrix R, and the background error covariance matrix BH^{T} at the time of each repetition performed at the timings (n) by the determination unit 36, and to use these updated values to calculate the weighting matrix W.

### Test Examples

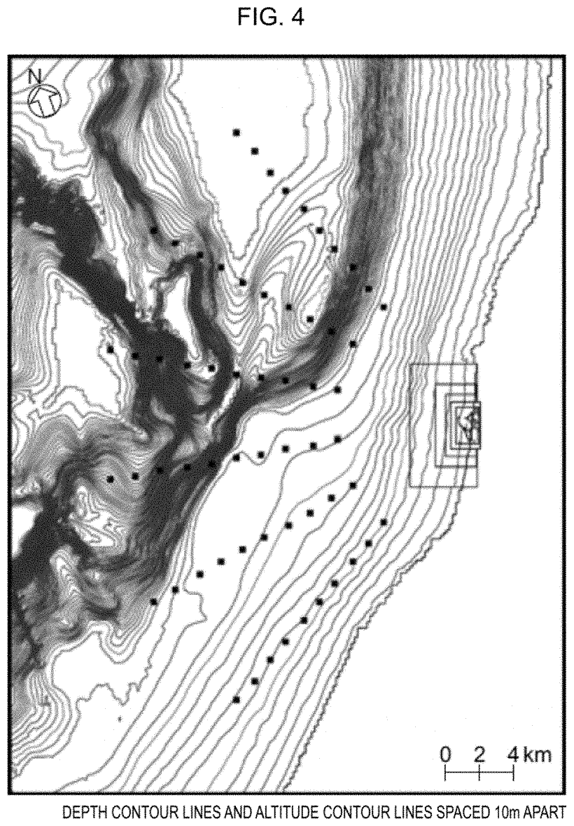

In order to evaluate the capability of predicting a tsunami by employing the procedure of the present exemplary embodiment, in a real terrain model based on an actual marine radar installation, a tsunami prediction test using data assimilation was performed with the only marine radar flow velocity observation value being the flow rate in a line-of-sight direction obtained from a numerical simulation in which a previously established tsunami wave source was disposed. In the test, exposure to the seabed, and the run-up to the land were considered, and a test using non-linear long wave theory was performed. As is shown in FIG. 4, the calculation area of the data assimilation tsunami prediction is limited to the vicinity of the marine radar observable range (i.e., east-west 43.2 km; north-south 57.6 km). The lattice spacing is sequentially subdivided from 240 m→80 m→40 m→20 m→0 m→5 m, and a lattice area of 10 m or greater was used for the onshore perfect reflection conditions, and only the lattice area of 5 m was used for the run-up boundary conditions.

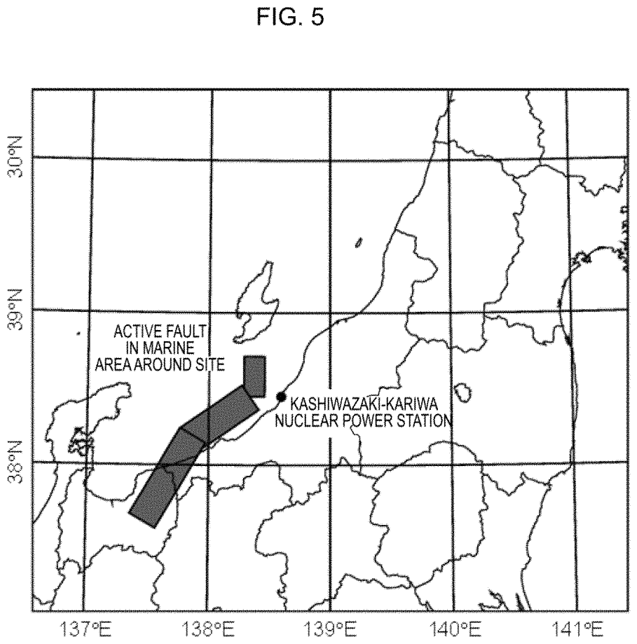

As the tsunami wave sources, active faults in marine areas around sites (i.e., lengths of 29/55/72 km, widths of 21/26/26 km, strikes of 0/55/30°, an upper edge depth of 2.5 km, tilt angles of 45/35/35°, slip angles of 62/96/90°, a slip amount of 7.7 m, and a magnitude of 8.0 Mw) were assumed. The positions of each wave source are shown in FIG. 5.

The calculation conditions are shown in Table 1.

| | |
|---|---|
| Analysis Area | Around Kashiwazaki-Kariwa Nuclear Power Station (43.2 km E-W × 57.6 km N-S) |
| Mesh Structure | Sequential Subdivisions of 240 m → 80 m → 40 m →20 m → 10 m → 5 m |
| Fundamental Equation | Non-Linear Long Wave Theory |
| Calculation Scheme | Goto/Ogawa Method (1982) |
| Boundary Conditions | Maritime Side: Free Transparency (Goto/Ogawa (1982)) |
| | Land Side: 80 m mesh or less in Model 1, and 5 m mesh in Model 2 only |
| | are Run-up Boundary Conditions of Kotani et. al. (1998), Remainder are |
| | Perfect Reflection Conditions |
| Overflow Conditions | Breakwaters/Weirs: Homma Formula (1940), Seawalls: Aida Formula |
| | (1977) |
| Seabed Friction | Manning's Roughness Coefficient n = 0.03 m−^{⅓} · s |
| Tide Level Conditions | T.M.S.L + 0.26 m (Average Tide Level) |
| Calculation Time Interval | Minimum of 0.0625 secs |
| Data Assimilation Interval | 120 secs |
| Calculation Time | 240 mins (4 hours) after Earthquake Occurrence |

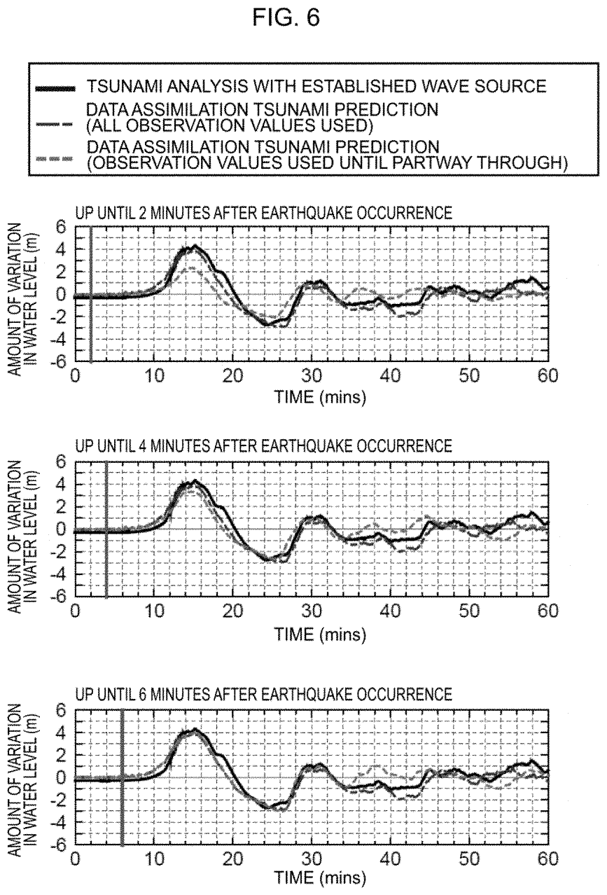

Results of the predictions in the tests are shown in FIG. 6. In the tests, data assimilation was performed using observation values until partway through the test for active faults in marine areas around the sites, and for how early a timing it was possible to make an accurate prediction was evaluated. In this evaluation, a background error correlation coefficient s° was fixed at 8 km. The water level timing history waveforms were evaluated when the observation values that were used were changed from up until 2 minutes after the earthquake occurred, then up until 4 minutes after the earthquake occurred, and then up until 6 minutes after the earthquake occurred. Because the observation intervals of the flow velocity were set at 2 minutes, in a case in which the observation values up until 2 minutes after the earthquake occurred were used, only one data assimilation was made. In this case as well, although the prediction of the water level was an underestimation, the arrival time of the tsunami could still be roughly predicted. When, using the observation values up until 4 minutes after the earthquake occurred, two data assimilations could be made, then in the case of the first wave, the prediction was substantially equivalent to the results when the first wave was assimilated until the end. When, using the observation values up until 6 minutes after the earthquake occurred, three data assimilations could be made, predictions could be made until roughly 34 minutes after the earthquake occurred. In this way, it is possible to predict the arrival time of a tsunami in a short time if data is input, and it could be confirmed that if assimilations were able to be advanced for a plurality of times, then the water level waveform for approximately the next 30 minutes could be predicted.

As has been described above, it can bee seen that it is possible to accurately predict the water level of a wave in a short time by using a data assimilation procedure.

Priority is claimed on Japanese Patent Application No. 2018-186537, filed Oct. 1, 2018, the disclosure of which is incorporated herein by reference.

All references, patent applications and technical specifications cited in the present specification are incorporated by reference into the present specification to the same extent as if the individual references, patent applications and technical specifications were specifically and individually recited as being incorporated by reference.

1. A tsunami prediction device that, taking a flow velocity in a light-of-sight direction of a wave at each observation location as inputs, predicts a water level of the wave at a prediction subject location, comprising:
an input portion that receives inputs of a flow velocity in a line-of-sight direction of a wave at each observation location;
a prediction portion that predicts states including the water level of the wave at the prediction subject location;
an estimation portion that, in a case in which inputs of the flow velocity in a line-of-sight direction of the wave at each observation location have been received, estimates states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix; and
a determination portion that causes the predictions of the states by the prediction portion and the estimation of the states by the estimation portion to be repeated until predetermined conditions have been satisfied, wherein
the predictions of the states by the prediction portion are made based on the states estimated by the estimation portion in the immediately previous repetition, or on the states predicted by the prediction portion in the immediately previous repetition.

2. The tsunami prediction device according to claim 1, wherein the states include a water level and a linear flow rate.

3. The tsunami prediction device according to claim 2, wherein the states include a water level, a linear flow rate in the line-of-sight direction, and a linear flow rate in an orthogonal direction relative to the line-of-sight direction.

4. The tsunami prediction device according to claim 3, wherein the observation matrix is determined by performing a linear approximation on a relationship between the flow velocity in the line-of-sight direction, the linear flow rate in the line-of-sight direction, and a still water depth.

5. A tsunami prediction method in which, taking a flow velocity in a light-of-sight direction of a wave at each observation location as inputs, a water level of the wave at a prediction subject location is predicted, comprising:
receiving inputs of a flow velocity in a line-of-sight direction of the wave at each observation location;
predicting states including the water level of the wave at the prediction subject location;
in a case in which inputs of the flow velocity in a line-of-sight direction of the wave at each observation location have been received, estimating states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix; and
causing the predictions of the states and the estimations of the states to be repeated until predetermined conditions have been satisfied, wherein
the predictions of the states are made based on the states estimated in the immediately previous repetition, or on the states predicted in the immediately previous repetition.

6. A computer-readable storage medium that, taking a flow velocity in a light-of-sight direction of a wave at each observation location as inputs, predicts a water level of the wave at a prediction subject location, and that causes a computer to execute processing comprising:
receiving inputs of a flow velocity in a line-of-sight direction of the wave at each observation location;
predicting states including the water level of the wave at the prediction subject location;
in a case in which inputs of the flow velocity in a line-of-sight direction of the wave at each observation location have been received, estimating states of the wave including the water level thereof at the prediction subject location based on a difference between the input flow velocity in a line-of-sight direction of the wave at each observation location, and the flow velocity in a line-of-sight direction of the wave at each observation location that is obtained by converting states of the wave including the water level thereof at the prediction subject location that were predicted for the observation locations using a predetermined observation matrix; and
causing the predictions of the states and the estimations of the states to be repeated until predetermined conditions have been satisfied, wherein
the predictions of the states are made based on the states estimated in the immediately previous repetition, or on the states predicted in the immediately previous repetition.
